(19) United States
(12) Patent Application Publication
(10) Pub. No.: US 2010/0122742 A1
(43) Pub. Date: May 20, 2010

(54) FLUID CONTROL THROTTLE VALVE

(76) Inventor: Hsiao-Mei Lin, Dali City (TW)

Correspondence Address: Dr. BANGER SHIA;Patent Office of Bang Shia, 102 Lindencrest Ct, Sugar Land, TX, 77479-5201, US

(21) Appl. No.: 12/275,116

(22) Filed: Nov. 20, 2008

(51) Int. Cl. F16K 31/12

(52) U.S. Cl. 137/497

(57) ABSTRACT

A fluid control throttle valve includes a first tube and a second tube, both of which have an inner passage respectively. Between the first and second tubes are disposed an adjusting element and a cylindrical communicating element, wherein the adjusting element has a central axis and a plurality of throttling orifices axially disposed therein. The distance between the central axis and the throttling orifices, respectively, is substantially the same with each other, while the throttling orifices are arranged radially around the central axis of the adjusting element, wherein a bore diameter of at least one throttling orifice is different from that of the other throttling orifices. In addition, the communicating element has a through hole axially disposed therein. The communicating element is axially rotatable with respect to the central axis of the adjusting element, wherein the through hole thereof selectively communicates a selected throttling orifice.

### BACKGROUND OF THE INVENTION

1. Field of the Invention

The present invention relates to a fluid control throttle valve for a reverse osmosis system.

2. Description of the Prior Art

Conventional throttle valve usually provides single throttle orifice for the fluid to flow therethrough. However, if a user wants to adjust the ratio of the flow between a pure water outlet and a waste water outlet of a reverse osmosis system, he/she has to buy another throttle valve with a different bore diameter. Not only is it a waste of money, but it also costs much trouble to install and uninstall the throttle valves.

The present invention has arisen to mitigate and/or obviate the afore-described disadvantages.

### SUMMARY OF THE INVENTION

The main object of the present invention is to provide a throttle valve for a reverse osmosis system that allows users to adjust the flow thereof.

To achieve the above object, the throttle valve provided by the present invention comprises a first tube and a second tube, both of which have an inner passage respectively. Between the first and second tubes are disposed an adjusting element and a cylindrical communicating element, wherein the adjusting element has a central axis and a plurality of throttling orifices axially disposed therein;

a distance between the central axis and the throttling orifices, respectively, is substantially the same with each other, while the throttling orifices are arranged radially around the central axis of the adjusting element, wherein a bore diameter of at least one throttling orifice is different from that of the other throttling orifices;

the communicating element has a through hole, corresponding to the throttling orifices, axially disposed therein, and the communicating element is axially rotatable with respect to the central axis of the adjusting element, wherein the through hole thereof selectively communicates one of the throttling orifices, so as to communicate the inner passages of the first and the second tubes.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a breakdown drawing showing a throttle valve in accordance with a preferred embodiment of the present invention;

FIG. 2 is a diagram showing an adjusting element in accordance with a preferred embodiment of the present invention;

FIG. 3 is a combination drawing showing a throttle valve in accordance with a preferred embodiment of the present invention;

FIG. 4 is an AA profile of the throttle valve in FIG. 3;

FIG. 5 is a diagram showing a flow direction in a throttle valve in accordance with a preferred embodiment of the present invention.

### DETAILED DESCRIPTION OF THE PREFERRED EMBODIMENTS

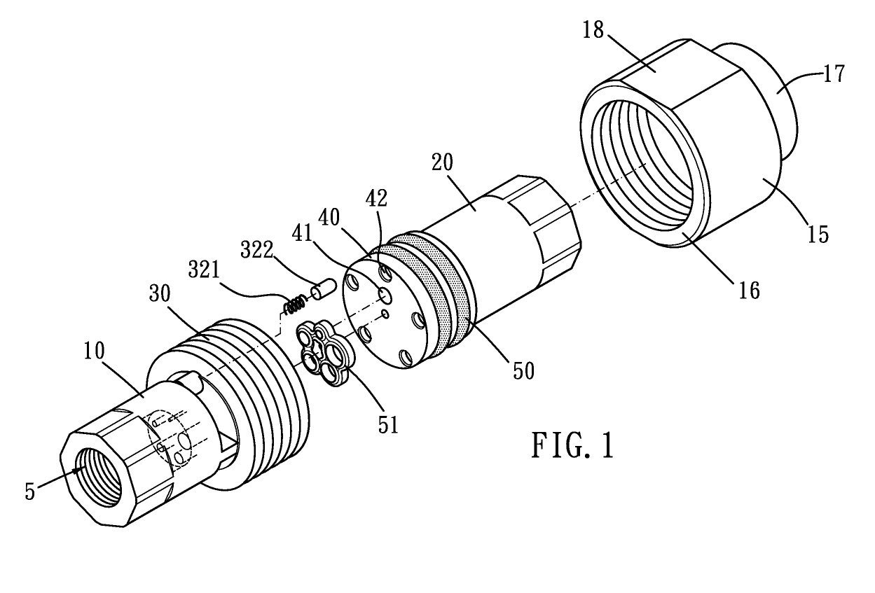

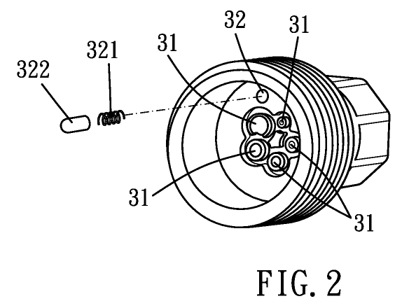

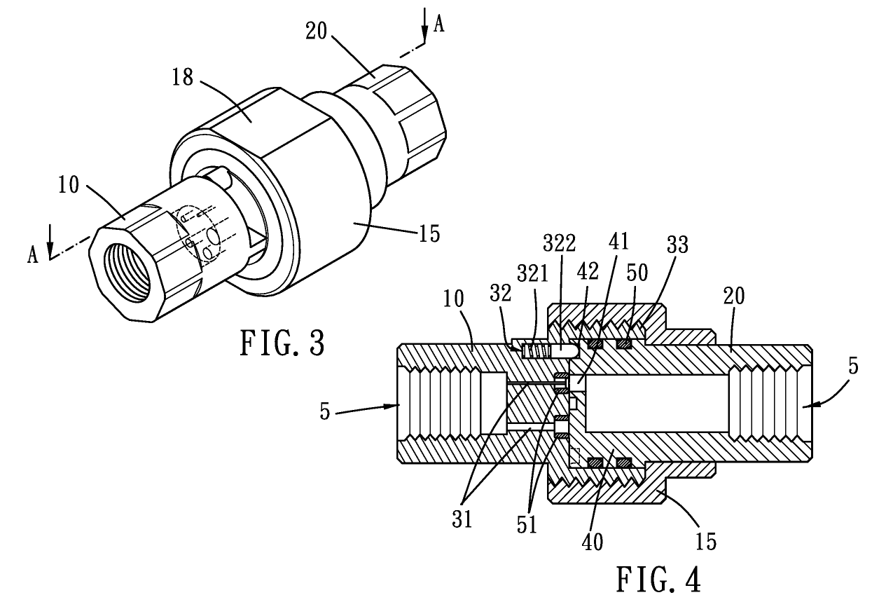

Please refer to FIG. 1-4. The fluid control throttle valve, installed on a waste water outlet of a reverse osmosis system, provided by the present invention comprises a first tube 10, a second tube 20 and a sleeve 15. Both of the first and the second tubes 10, 20 have an inner passage 5 respectively. Between the first and the second tubes 10, 20 are disposed an adjusting element 30 and a cylindrical communicating element 40. The adjust element 30 and the communicating element 40 are formed integrally in one piece with the first and the second tubes 10, 20 respectively.

Moreover, the sleeve 15 is used to connect the first and the second tubes 10, 20. The sleeve 15 has a first end 16 and a second end 17. The first end 16 has an inner thread, and an outer surface of the adjusting element 30 has an outer thread, so that the adjusting element 30 is mounted with the first end 16 of the sleeve 15. The second end 17 of the sleeve 15 defines an inner space with an opening, while an internal diameter of the opening is smaller than that of the inner space. The communicating element 40 is therefore received in and rotatable with respect to the inner space, and the second tube 20 axially extends out of the opening from the communicating element 40.

Besides, the adjusting element 30 has a central axis and a plurality of throttling orifices 31 axially disposed therein. A distance between the central axis and the throttling orifices 31, respectively, is substantially the same with each other, while the throttling orifices 31 are arranged radially around the central axis of the adjusting element 30. A bore diameter of at least one throttling orifice 31 is different from that of the other throttling orifices 31. In the present embodiment, the bore diameters of the throttling orifices 31 are different from each other, allowing users to choose a desired one and therefore, to adjust the flow of the waste water outlet.

In addition, the communicating element 40 has a through hole 41, corresponding to the throttling orifices 31, axially disposed therein. The communicating element 40 is axially rotatable with respect to the central axis of the adjusting element 30, and the through hole 41 thereof selectively communicates one of the throttling orifices 31, so as to communicate the inner passages 5 of the first and the second tubes 10, 20.

The communicating element 40 has a plurality of positioning notches 42 corresponding to the throttling orifices 31. More specifically, each extension line of the throttling orifice 31 and its corresponding positioning notch 41 passes through the central axis of the adjusting element 30. Moreover, the adjusting element 30 has a receiving groove 32. In the receiving groove 32 are disposed a resilient object 321, such as a spring, and a positioning object 322. Both ends of the resilient object 321 urge the resilient receiving groove 32 and the positioning object 322 respectively. A end of the positioning object 322, away from the resilient object 321, is selectively urged into one of the positioning notches 42. When the communicating element 40 axially rotates with respect to the central axis of the adjusting element 30, the positioning object 322 is pushed back into the receiving groove 42. When the through hole 41 communicates one of the throttling orifices 31, the positioning object 322 is urged into the positioning notch 42 corresponding to the communicated throttling orifice 31, so as to position both the adjusting element 30 and the communicating element 40.

Furthermore, the adjusting element 30 is formed with an annular bushing 33 axially extending toward the communicating element 40 side. An outer surface of the annular bushing 33 has an outer thread to be engaged with the inner thread of the sleeve 15. Besides, the annular bushing 33 receives the communicating element 40 therein and two gaskets are installed between an inner surface of the annular bushing 33 and an outer surface of the communicating element 40. In addition, a gasket 51 is installed around an opening of each throttling orifice 31. The above-mentioned gaskets are provided to prevent the throttle valve from leakage.

Two engaging surfaces 18 are formed on an outer surface of the sleeve 15, so as to be engaged with a wrench, fastening the first and the second tubes 10, 20 tightly. Moreover, an outer surface of the communicating element 40 has marks corresponding to the throttling orifices 31, which can be used to inform users of the position of the throttling orifices and/or the current flow amount of the throttle valve.

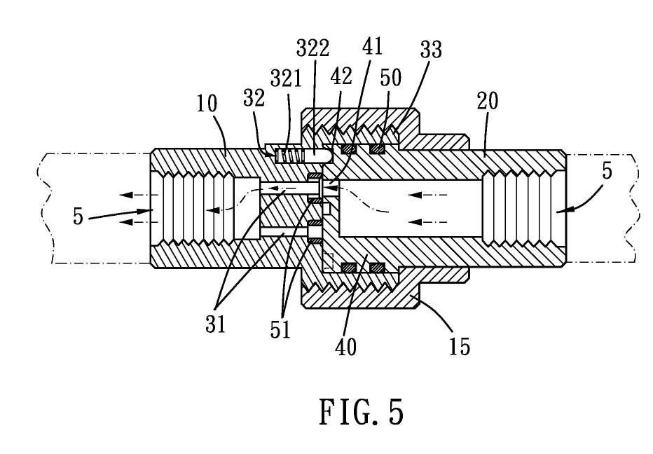

Now, please refer to FIG. 5. In the present embodiment, the first tube 10 connects to an outlet leading to the surrounding, and the second tube 20 connects to an inlet communicating a reverse osmosis system. Therefore, the water flows from the second tube 20, via the through hole 41 and the throttling orifice 31, adjusting the flow amount of the water, and then flows out of the first tube 10. When varying the flow amount of the water, the user simply turns the communicating element 40 to let the through hole 41 communicates a throttling orifice 31 with a different bore diameter. Also, the throttle valve of the present invention can be installed reversely, wherein the first tube 10 communicates the reverse osmosis system and the second tube 20 communicates the surrounding. The same result can be achieved as well.

The throttle valve of the present invention is designed to realize the follow efficacy:

1. A plurality of throttling orifices are axially and radially disposed around the central axis of the adjusting element, such that the users can vary the flow amount of the water by simply turning the communicating element. Therefore, the throttle valve of the present invention facilitates the flow amount control and allows users to adjust the ratio of the flow between the outlet of the waste water and the outlet of the pure water of the reverse osmosis system quickly.

2. The present invention provides more than one flow amount for the users to choose from, so they wont have to buy multiple conventional throttle valves, each of which provides only one flow amount. The cost of both money and time is, therefore, reduced.

3. Between the adjusting element and the communicating element is installed a positioning means, the combination of the positioning notches and the positioning object, which allows the user to communicate the through hole and the throttling orifice without much effort, and prevents the adjusting element from rotating spontaneously resulted from the impact of the water pressure.

What is claimed is:

1. A fluid control throttle valve for a reverse osmosis system, comprising
a first tube and a second tube, both of which having an inner passage respectively, between the first and second tubes being disposed an adjusting element and a cylindrical communicating element, wherein the adjusting element has a central axis and a plurality of throttling orifices axially disposed therein;
a distance between the central axis and the throttling orifices, respectively, being substantially the same with each other, while the throttling orifices being arranged radially around the central axis of the adjusting element, wherein a bore diameter of at least one throttling orifice is different from that of the other throttling orifices;
the communicating element having a through hole, corresponding to the throttling orifices, axially disposed therein, and the communicating element being axially rotatable with respect to the central axis of the adjusting element, wherein the through hole thereof selectively communicates one of the throttling orifices, so as to communicate the inner passages of the first and the second tubes.

2. The fluid control throttle valve according to claim 1, wherein the adjusting element and the communicating element are formed integrally in one piece with the first tube and second tube respectively.

3. The fluid control throttle valve according to claim 2, further comprising a sleeve for connecting the first and the second tubes, wherein the sleeve has a first end and a second end, the first end has an inner thread, and an outer surface of the adjusting element has an outer thread, so that the adjusting element is mounted with the first end of the sleeve; the second end of the sleeve defines an inner space with an opening, while an internal diameter of the opening is smaller than that of the inner space, the communicating element is received in and rotatable with respect to the inner space, and the second tube axially extends out of the opening from the communicating element.

4. The fluid control throttle valve according to claim 3, wherein the communicating element has a plurality of positioning notches corresponding to the throttling orifices, and the adjusting element has a receiving groove, in the receiving groove are disposed a resilient object and a positioning object, both ends of the resilient object urge the receiving groove and the positioning object respectively, while a end of the positioning object, away from the resilient object, is selectively urged into one of the positioning notches; when the communicating element axially rotates with respect to the central axis of the adjusting element, the positioning object is pushed back into the receiving groove; when the through hole communicates one of the throttling orifices, the positioning object is urged into the positioning notch corresponding to the communicated throttling orifice, so as to position both the adjusting element and the communicating element.

5. The fluid control throttle valve according to claim 3, wherein the adjusting element has a plurality of positioning notches corresponding to the throttling orifices, and the communicating element has a receiving groove, in the receiving groove are disposed a resilient object and a positioning object, both ends of the resilient object urge the receiving groove and the positioning object respectively, while a end of the positioning object, away from the resilient object, is selectively urged into one of the positioning notches; when the communicating element axially rotate with respect to the central axis of the adjusting member, the positioning object is pushed back into the receiving groove; when the through hole communicates one of the throttling orifices, the positioning object is urged into the positioning notch corresponding to the communicated throttling orifice, so as to position both the adjusting element and the communicating element.

6. The fluid control throttle valve according to claim 4, wherein openings of the positioning notches are formed in an arc-shaped round chamfer, so that the positioning object slides smoothly out of the selected positioning notch along the chamfer when the communicating element rotates.

7. The fluid control throttle valve according to claim 5, wherein openings of the positioning notches are formed in an arc-shaped round chamfer, so that the positioning object slides smoothly out of the selected positioning notch along the chamfer when the communicating element rotates.

8. The fluid control throttle valve according to claim 1, wherein an outer surface of the communicating element has marks corresponding to the throttling orifices.

9. The fluid control throttle valve according to claim 1, wherein a gasket is installed around an opening of each throttling orifice.

10. The fluid control throttle valve according to claim 3, wherein at least two engaging surfaces are formed on an outer surface of the sleeve, so as to be engaged with a wrench.

11. The fluid control throttle valve according to claim 4, wherein at least two engaging surfaces are formed on an outer surface of the sleeve, so as to be engaged with a wrench.

12. The fluid control throttle valve according to claim 5, wherein at least two engaging surfaces are formed on an outer surface of the sleeve, so as to be engaged with a wrench.

13. The fluid control throttle valve according to claim 3, wherein the adjusting element is formed with an annular bushing axially extending toward the communicating element side, an outer surface of the annular bushing has an outer thread to be engaged with the inner thread of the sleeve, the annular bushing receives the communicating element therein and at least one gasket is installed between an inner surface of the annular bushing and an outer surface of the communicating element.

14. The fluid control throttle valve according to claim 4, wherein the adjusting element is formed with an annular bushing axially extending toward the communicating element side, an outer surface of the annular bushing has an outer thread to be engaged with the inner thread of the sleeve, the annular bushing receives the communicating element therein and at least one gasket is installed between an inner surface of the annular bushing and an outer surface of the communicating element.

15. The fluid control throttle valve according to claim 5, wherein the adjusting element is formed with an annular bushing axially extending toward the communicating element side, an outer surface of the annular bushing has an outer thread to be engaged with the inner thread of the sleeve, the annular bushing receives the communicating element therein and at least one gasket is installed between an inner surface of the annular bushing and an outer surface of the communicating element.
